(19) United States
(12) Patent Application Publication
(10) Pub. No.: US 2012/0026568 A1
(43) Pub. Date: Feb. 2, 2012

(54) LIQUID DEVICE AND DISPLAY APPARATUS

(75) Inventor: Kenichi Takahashi, Kanagawa (JP)

(73) Assignee: Sony Corporation, Tokyo (JP)

(21) Appl. No.: 13/187,684

(22) Filed: Jul. 21, 2011

(30) Foreign Application Priority Data
Jul. 28, 2010 (JP) 2010-169269

(51) Int. Cl. G02B 26/08

(52) U.S. Cl. 359/226.3

(57) ABSTRACT

A liquid device includes: first and second substrates oppositely provided to each other at a distance; first and second partition walls provided between the first substrate and the second substrate to extend in a first and second directions, respectively; first and second electrodes respectively provided on both side surfaces of the second partition walls; liquids filling liquid chambers formed by the first and the second partition walls and having interfaces varying in response to voltages applied by the first and second electrodes; and first and second extraction electrodes wired on the first substrate along contact lines between the first substrate and the side surfaces of the second partition walls and externally extracted from joint parts between the first partition walls and the first substrate, wherein the first electrodes are connected to the first extraction electrodes, and the second electrodes are connected to the second extraction electrodes.

### FIELD

The present disclosure relates to a liquid device and a display apparatus, and specifically, to a liquid device and a display apparatus that electrically control production of a prism effect or a lens effect for realization of three-dimensional display, for example.

### BACKGROUND

In related art, methods of realizing stereoscopic views by allowing right and left eyes of an observer to view parallax images with generated parallax are known, and methods requiring use of dedicated glasses for the observer to realize stereoscopic views and methods requiring no dedicated glasses are known.

The methods requiring dedicated glasses are applied to screening equipment in movie theaters and television receivers, for example. The methods requiring no dedicated glasses are intended to be applied to displays of portable electronic equipment such as smartphones, mobile phones, portable game machines, and netbook computers in addition to the television receivers.

As a specific method of realizing the method requiring no dedicated glasses, a combination of a screen of a two-dimensional display apparatus such as a liquid crystal display and an optical device for three-dimensional display that deflects display image light from the two-dimensional display apparatus in plural viewing angle directions may be cited.

As the optical device for three-dimensional display, a lens array in which plural cylindrical lenses are arranged in parallel is known. For example, in the case of twin-lens stereoscopic view, a stereoscopic effect is obtained for the visual perception of the observer by allowing right and left eyes to view different parallax images. Accordingly, to realize this, right and left parallax images are adapted to appropriately reach the right and left eyes of the observer by arranging plural cylindrical lenses extending in the longitudinal directions in parallel in the lateral direction with respect to the display surface of the two-dimensional display apparatus and deflecting the display image light from the two-dimensional display apparatus in the right and left directions.

In addition to the cylindrical lenses, a liquid device using an electrolyte and an oil (for example, see Patent Document 1 (JP-T-2007-534013)) and a lens array device using liquid crystal (for example, see Patent Document 2 (JP-A-2008-9370)) are known.

The liquid device utilizes an electrowetting phenomenon (electrocapillary phenomenon) that, by applying a voltage between a liquid having a conductive property and an electrode, the shape of the surface of the liquid changes.

FIGS. 1A and 1B show an example of a configuration of a liquid device, and are sectional views along the xz-plane of the liquid device. Further, FIG. 1A shows a state in which no voltage is applied and FIG. 1B shows a state in which voltages are applied.

In a liquid device 10, a lower substrate 11 and an upper substrate 12 in parallel to the xy-plane are oppositely provided, y-direction partition walls 13 and x-direction partition walls (not shown) are provided on the lower substrate 11, and spacers 17 are provided between the y-direction partition walls 13 and the upper substrate 12. A transparent electrode 18 is provided on the surface of the upper substrate 12 facing the lower substrate 11. On the wall surfaces of the y-direction partition wall 13, a partition wall side surface electrode 14A is provided on one surface and a partition wall side surface electrode 14B is provided on the other surface. Note that, on the y-direction partition walls 13 on the ends of the liquid device 10 (in the drawing, y-direction partition walls 13-0, 13-3), the partition wall side surface electrode 14A or 14B is provided only on one of the wall surfaces. Further, respective liquid chambers formed by the respective y-direction partition walls 13 and the x-direction partition walls are filled with oils 15 and electrolytes 16. The display surface of the two-dimensional display apparatus is provided under the lower substrate 11.

For the oil 15, a material that is incompatible with the electrolyte 16, holds its interface, and has an optical refractive index higher than that of the electrolyte 16 is used.

In the case where no current is flown between the partition wall side surface electrodes 14A, 14B and the transparent electrode 18 and no voltage is applied to the liquids (the oil 15 and the electrolyte 16), the interface between the oil 15 and the electrolyte 16 forms a concave curve as shown in FIG. 1A.

On the other hand, when a predetermined voltage is applied to the liquids (the oil 15 and the electrolyte 16) by flowing a current from the partition wall side surface electrodes 14A, 14B and grounding the transparent electrode 18, for example, as shown in FIG. 1B, the interface between the oil 15 and the electrolyte 16 forms a convex curve. The shape of the interface between the oil 15 and the electrolyte 16 is controllable by the applied voltage.

### SUMMARY

As described above, in related art, proposals for the liquid device have been made, however, particularly, any specific proposal has not been made for the electrode structure of the liquid device in consideration of implementation in a display apparatus or the like.

Thus, it is desirable to propose a structure of a liquid device in consideration of implementation in a display apparatus or the like.

A liquid device according to one embodiment of the present disclosure includes first and second substrates oppositely provided to each other at a distance, first partition walls provided between the first substrate and the second substrate to extend in a first direction, second partition walls provided between the first substrate and the second substrate to extend in a second direction different from the first direction, first and second electrodes respectively provided on both side surfaces of the second partition walls, liquids filling liquid chambers formed by the first and the second partition walls and having interfaces varying in response to voltages applied by the first and second electrodes, and first and second extraction electrodes wired on the first substrate along contact lines between the first substrate and the side surfaces of the second partition walls and externally extracted from joint parts between the first partition walls and the first substrate, wherein the first electrodes are connected to the first extraction electrodes, and the second electrodes are connected to the second extraction electrodes.

One of the first and second extraction electrodes may be externally extracted from one end side of ends of the liquid device in the second direction, and the other is externally extracted from the other end side of the ends of the liquid device in the second direction.

At least one or more of the first partition walls may be provided between the ends of the liquid device in addition to those on the ends in the second direction.

The first electrode may be provided on an entire of one of the side surfaces of the second partition wall, and the second electrode may be provided on an entire of the other of the side surfaces of the second partition wall.

The first electrode may be provided in a region except an electrodeless region containing a part of the contact line with the first substrate of one of the side surfaces of the second partition wall, and the second electrode may be provided in a region except an electrodeless region containing a part of the contact line with the first substrate of the other of the side surfaces of the second partition wall.

The interface between the liquids filling the liquid chamber may be adapted to change to a concave curve, a convex curve, or a flat surface in response to the voltage applied by the first and second electrodes.

A liquid device according to another embodiment of the present disclosure includes first and second substrates oppositely provided to each other at a distance, first partition walls provided between the first substrate and the second substrate, second partition walls provided between the first substrate and the second substrate, first and second electrodes respectively provided on both side surfaces of the second partition walls, liquids having interfaces varying in response to voltages applied by the first and second electrodes; and first and second extraction electrodes wired on the first substrate and externally extracted from joint parts between the first partition walls and the first substrate, wherein the first electrodes are connected to the first extraction electrodes, and the second electrodes are connected to the second extraction electrodes.

A display apparatus according to still another embodiment of the present disclosure includes a display unit that performs image display, a liquid device oppositely provided at a display surface side of the display unit, and supply means for supplying electric power to the liquid device, and the liquid device includes first and second substrates oppositely provided to each other at a distance, first partition walls provided between the first substrate and the second substrate to extend in a first direction, second partition walls provided between the first substrate and the second substrate to extend in a second direction different from the first direction, first and second electrodes respectively provided on both side surfaces of the second partition walls, liquids filling liquid chambers formed by the first and the second partition walls and having interfaces varying in response to voltages applied by the first and second electrodes, and first and second extraction electrodes wired on the first substrate along contact lines between the first substrate and the side surfaces of the second partition walls and externally extracted from joint parts between the first partition walls and the first substrate, wherein the first electrodes are connected to the first extraction electrodes, and the second extraction electrodes are connected to the second electrodes.

In the embodiments of the present disclosure, the interface of the liquids filling the liquid chamber formed by the first and second partition walls are varied in response to the applied voltages.

According to the one embodiment of the present disclosure, a structure of a liquid device in consideration of implementation in a display apparatus or the like may be proposed.

Further, according to the embodiments of the present disclosure, the liquid device may be allowed to function as liquid lenses, liquid prisms, or a liquid Fresnel lens.

According to the embodiments of the present disclosure, images may be displayed via liquid lenses, liquid prisms, or a liquid Fresnel lens using a liquid device.

### BRIEF DESCRIPTION OF THE DRAWINGS

FIGS. 1A and 1B are sectional views showing an example of a configuration of a liquid device in related art.

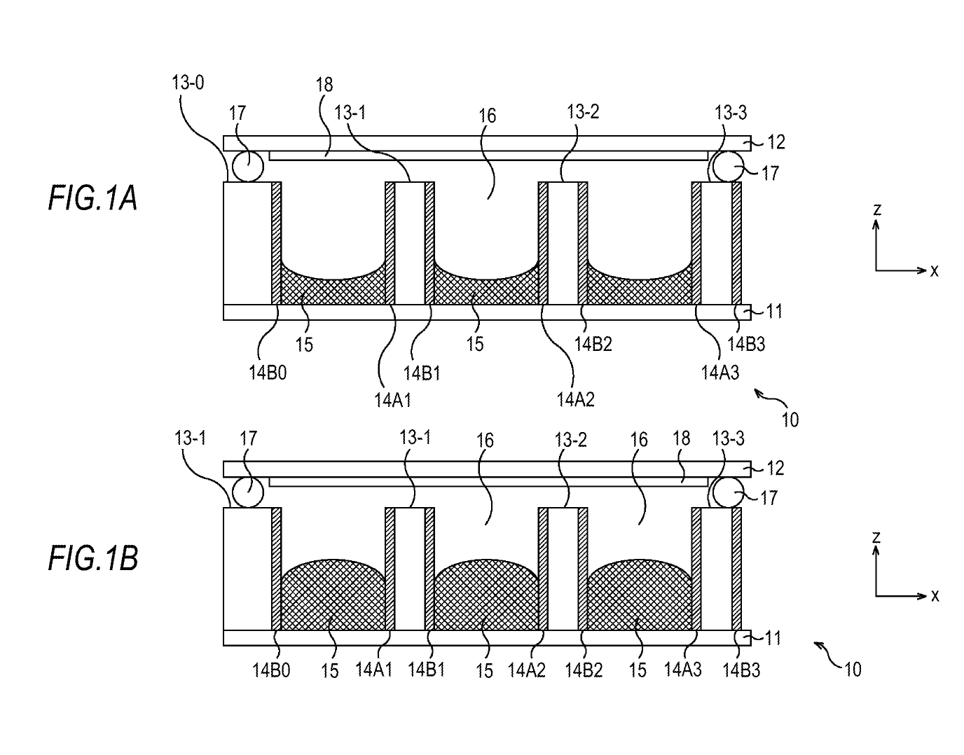

FIG. 2 is a perspective view showing a configuration example of a liquid device 20 as the first embodiment.

FIG. 3 is an xz-plane sectional view of the liquid device 20.

FIG. 4 is an xz-plane sectional view showing another structure example of extraction electrodes.

FIGS. 5A to 5C are sectional views of the liquid device 20 along the xz-plane.

FIG. 6 is a perspective view showing a configuration example of a liquid device 40 as the second embodiment.

FIG. 7 is a perspective view showing a configuration example of a liquid device 50 as the third embodiment.

FIGS. 8A and 8B are diagrams for explanation of a response time of a liquid chamber.

FIG. 9 shows a relationship between the size of the liquid chamber and the response time.

FIG. 10 is an xy-plane sectional view showing a structure of extraction electrodes 26.

### DETAILED DESCRIPTION

As below, preferred embodiments for implementing the present disclosure (hereinafter, referred to as embodiments) will be explained in detail with reference to the drawings.

### 1. FIRST EMBODIMENT

### [Configuration Example of Liquid Device 20]

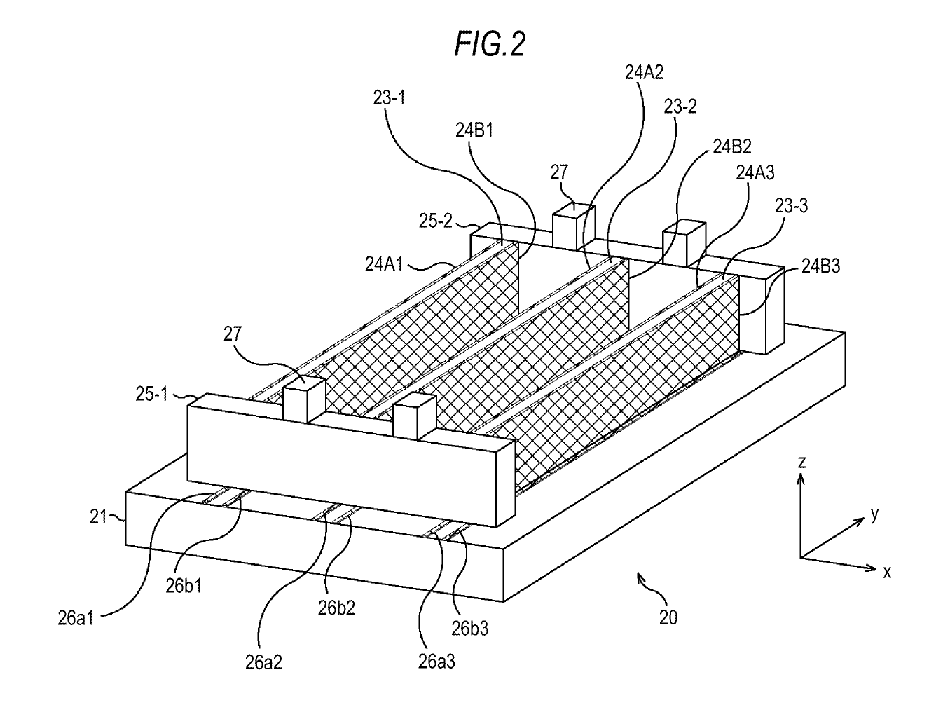

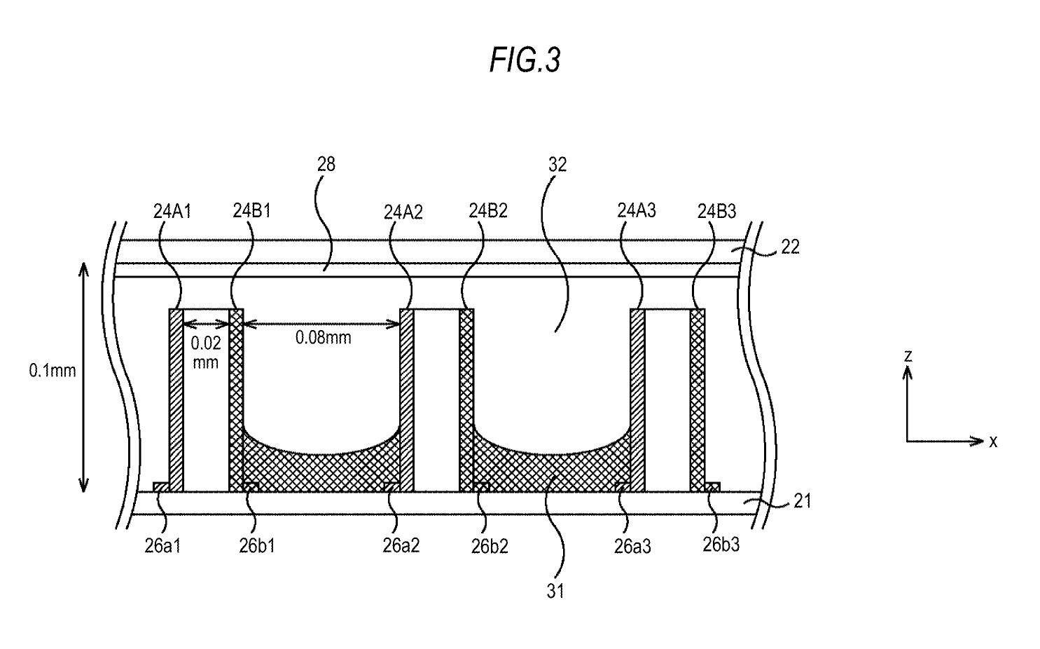

A liquid device 20 as the first embodiment of the present disclosure will be explained with reference to FIGS. 2 and 3. FIG. 2 is a partial perspective view of the liquid device 20, and FIG. 3 is a sectional view along the xz-plane of the liquid device 20.

The liquid device 20 is oppositely provided on a display surface of a two-dimensional display apparatus and functions as a liquid lens, a liquid prism, or a liquid.

In the liquid device 20, a lower substrate 21 and an upper substrate 22 of transparent glass or plastic in parallel to the xy-plane are oppositely provided, and plural y-direction partition walls 23 extending in the y direction and x-direction partition walls 25-1 and 25-2 extending in the x direction are provided on the lower substrate 21. A transparent electrode 28 is provided on the surface of the upper substrate 22 facing the lower substrate 21. On the x-direction partition walls 25, spacers 27 for holding the distance to the upper substrate 22 are provided. Further, liquid chambers are formed by the respective y-direction partition walls and the x-direction partition walls 25. Note that the positions and the number of the spacers 27 are arbitrary, and not limited to those in the illustrated embodiments. Further, the shape of the spacer 27 is not limited to a rectangular parallelepiped shown in the drawing, but may be a spherical shape, for example. Furthermore, the spacers 27 may be provided at the upper substrate 22 side. Moreover, the spacers 27 may be integrated with the x-direction partition walls 25 or the upper substrate 22.

Partition wall side surface electrodes 24A are deposited on the entire of one wall surfaces of the respective y-direction partition walls 23, and extraction electrodes 26a provided on the lower substrate 21 and extracted to the outside of the x-direction partition walls 25-1 and 25-2 are connected to the lower ends (at the lower substrate 21 side) of the partition wall side surface electrodes 24A. Similarly, partition wall side surface electrodes 24B are deposited on the entire of the other wall surfaces of the respective y-direction partition walls 23, and extraction electrodes 26b provided on the lower substrate 21 and extracted to the outside of the x-direction partition walls 25-1 and 25-2 are connected to the lower ends (at the lower substrate 21 side) of the partition wall side surface electrodes 24B. Note that, obviously, extraction electrodes (not shown) are also connected to the transparent electrode 28 of the upper substrate 22.

In this manner, by providing the extraction electrodes 26a and 26b outside of the x-direction partition walls 25-1 and 25-2, the voltages applied from the outside of the liquid device 20 to the liquids within the liquid chambers may be controlled.

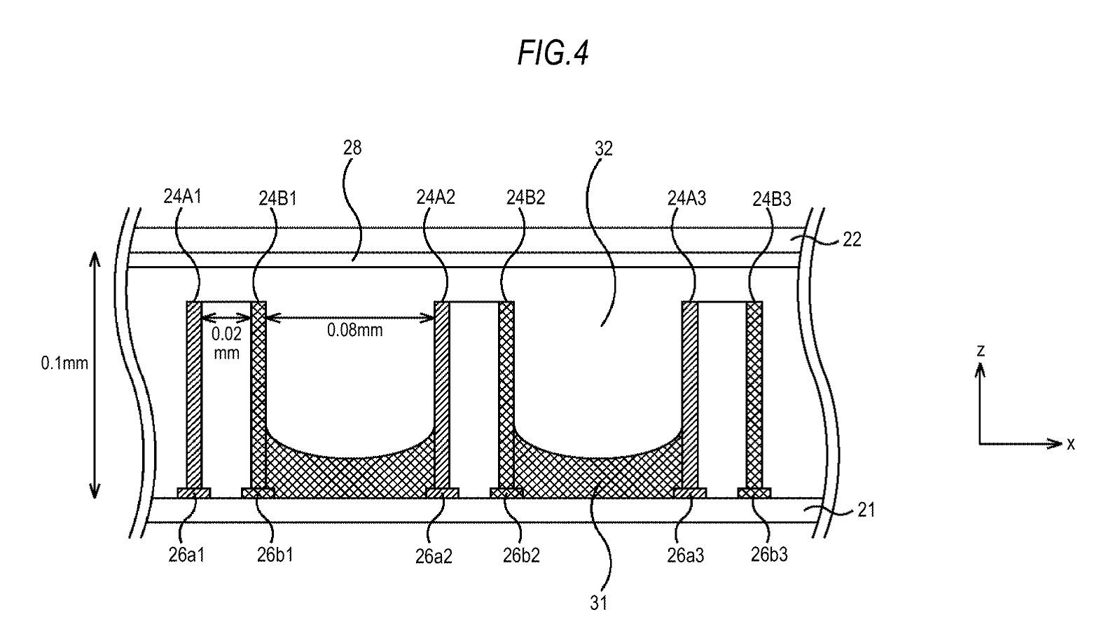

The extraction electrodes 26a and 26b may have structures projecting into the y-direction partition walls 23 as shown in FIG. 4. Thereby, the conduction between the partition wall side surface electrodes 24 and the extraction electrodes 26 may be more reliable. Note that, the adhesion of the bonded surfaces may be lower depending on the materials of the electrodes, the partition walls, and the lower substrate, and, in this case, the structures shown in FIG. 3 may be more preferable than the structures shown in FIG. 4.

Each liquid chamber is filled with an oil 31 and an electrolyte 32. For the oil 31, a material that is incompatible with the electrolyte 32, holds its interface, and has an optical refractive index higher than that of the electrolyte 32 is used.

The liquid chamber surface of the lower substrate 21 is subjected to coating treatment for providing an insulation property and repellency. The transparent electrode 28 provided on the upper substrate 22 is subjected to coating treatment for providing an insulation property and a hydrophilic property. The partition wall side surface electrodes 24A, 24B provided on the wall surfaces of the y-direction partition walls 23 and the liquid chamber surfaces of the x-direction partition walls 25 are subjected to coating treatment for providing an insulation property and a hydrophilic property. By the coating treatment, even when the liquids (the oils 31 and the electrolyte 32) move due to the application of the voltages, they are prevented from leaking to the outside of the liquid chamber and the partition walls. Further, sealing materials are applied to the joint parts between the y-direction partition walls 23 and the x-direction partition walls 25, which form an outer periphery of the liquid device 20, and thereby, the liquids are prevented from leaking from the liquid device 20.

### [Explanation of Operation]

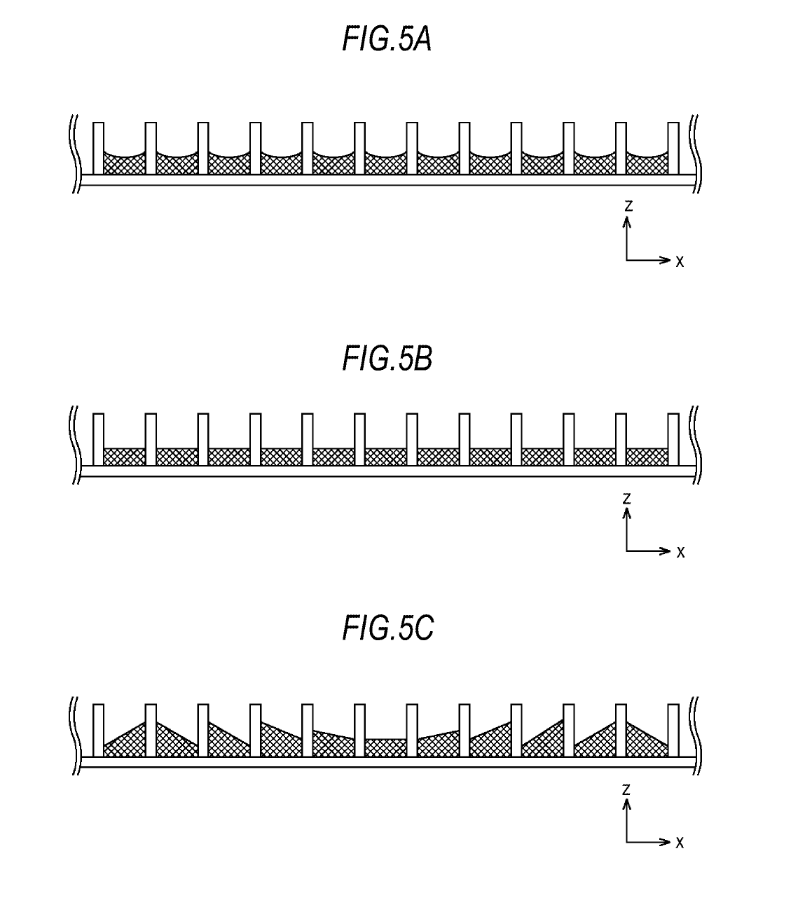

Next, an operation of the liquid device 20 will be explained with reference to FIGS. 5A to 5C. FIGS. 5A to 5C show sections along the xz-plane of the liquid device 20. In the liquid device 20, when no voltage is applied to the liquids (the oil 31 and the electrolyte 32), the interface between the oil 31 and the electrolyte 32 forms a concave curve as shown in FIG. 5A.

By applying voltages to the liquids of the respective liquid chambers, the interfaces in the respective liquid chambers may be controlled. Specifically, the interfaces in the respective liquid chambers may be controlled to be flat surfaces at the same angle as shown in FIG. 5B by applying the equal voltage to the liquids of the respective liquid chambers, or the angles of the interfaces in the respective liquid chambers may be individually controlled as shown in FIG. 5C by individually applying different voltages to the respective liquid chambers.

Thereby, the liquid chambers of the liquid device 20 may be allowed to function as liquid lenses or liquid prisms, or the plural liquid chambers may be allowed to function as a liquid Fresnel lens.

As shown in FIG. 5A, when no voltage is applied, the interface between the liquids forms the concave curve, and this is the same with respect to the yz-plane. Note that the width in the y direction on the yz-plane of the liquid chamber is larger than the width in the x direction on the xz plane, and thus, the concaved condition (the falling condition of the lowermost end) is more remarkable. In this case, by rapidly and continuously switching the voltage applied to the liquids and varying the shape of the interface, a defect that the interface (i.e., the lowermost layer of the electrolyte 32) attaches and is fixed to the lower substrate 21 may be caused, and a structure for preventing the defect is necessary.

### 2. SECOND EMBODIMENT

### [Configuration Example of Liquid Device 40]

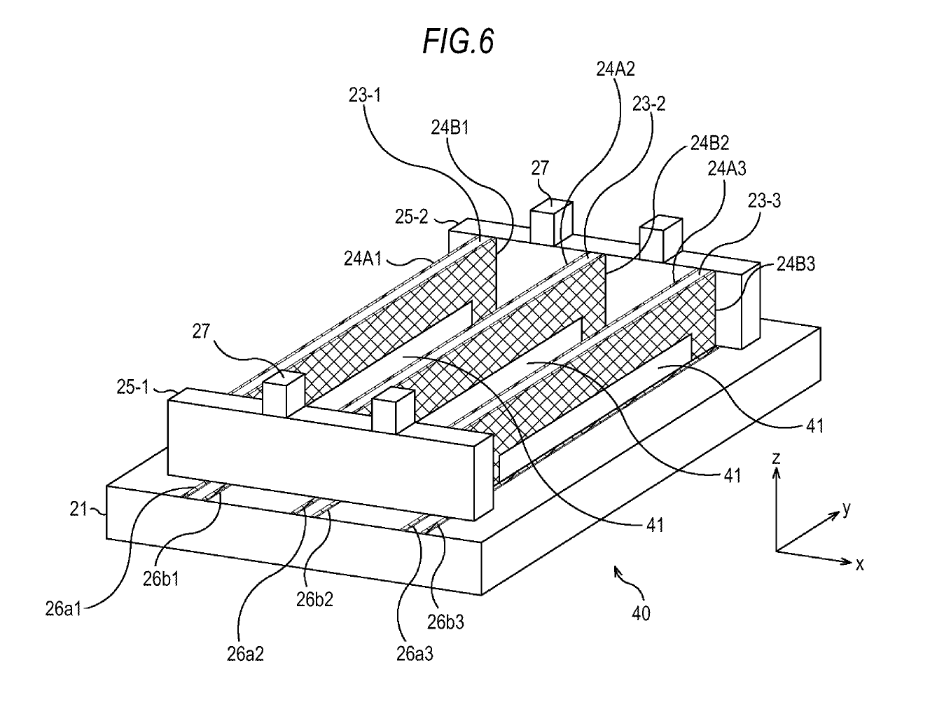

FIG. 6 is a perspective view of a liquid device 40 as the second embodiment of the present disclosure. The liquid device 40 has a structure for preventing the above described defect. The same numbers are assigned to the component elements in common with the liquid device 20 in FIG. 2, and their explanation will be omitted.

In the liquid device 40, the partition wall side surface electrodes 24A and 24B are not provided on the entire side surfaces of the y-direction partition walls 23 as in the liquid device 20 shown in FIG. 2, but the partition wall side surface electrodes 24A and 24B are deposited with electrodeless regions 41 spaced in the side surface lower parts of the y-direction partition walls 23. Therefore, the partition wall side surface electrodes 24A and 24B are connected to the extraction electrodes 26a or the extraction electrodes 26b only in the locations near the x-direction partition walls 25-1 and 25-2, respectively.

As described above, the partition wall side surface electrodes 24A and 24B provided on the wall surfaces of the y-direction partition walls 23 are subjected to coating treatment for providing an insulation property and a hydrophilic property, and the electrodeless regions 41 are subjected to coating treatment for providing an insulation property and repellency.

Thereby, even when the interface between the oil 31 and the electrolyte 32 falls toward the lower substrate 21 side, the above described defect is prevented by the repellency of the electrodeless regions 41.

### 3. THIRD EMBODIMENT

### [Configuration Example of Liquid Device 50]

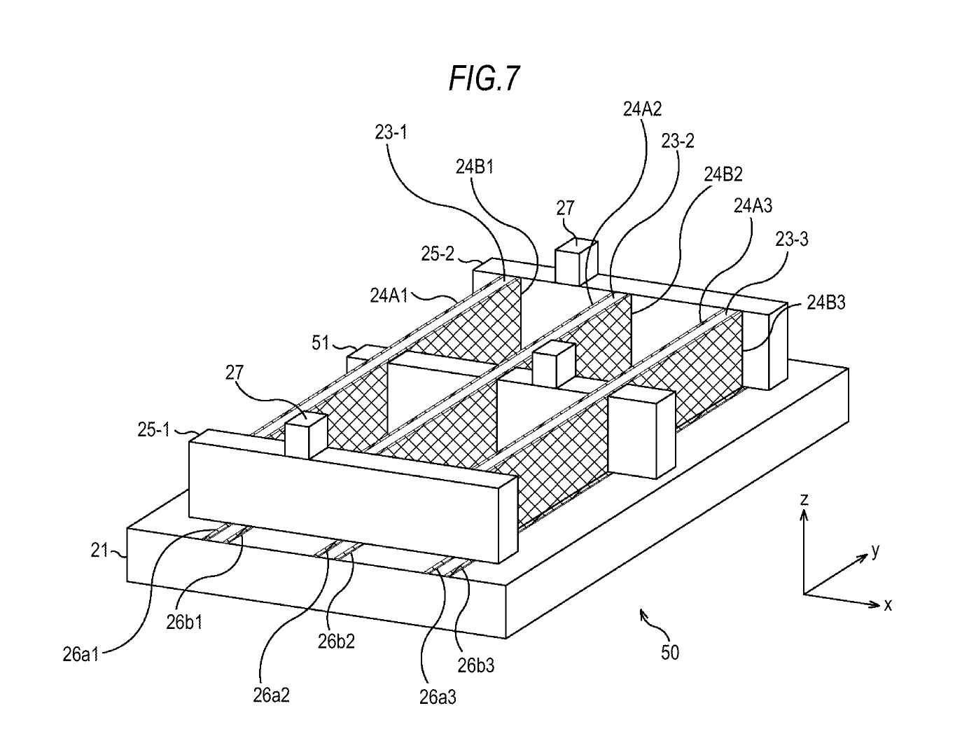

FIG. 7 is a perspective view of a liquid device 50 as the third embodiment of the present disclosure. The liquid device 50 also has a structure for preventing the above described defect. The same numbers are assigned to the component elements in common with the liquid device 20 in FIG. 2, and their explanation will be omitted.

The liquid device 50 has an x-direction partition wall 51 in addition to the liquid device 20 shown in FIG. 2. One or more x-direction partition walls 51 maybe added. By adding the x-direction partition wall 51, the width of the respective liquid chambers in the y direction is shorter than that of the liquid device 20. Therefore, the concaved condition of the interface on the yz-plane of the liquid chamber is more relaxed than that of the liquid device 20, and the above described defect is prevented.

### 4. MODIFIED EXAMPLE

The x-direction partition wall 51 may be added as in the liquid device 50, and further, the electrodeless regions 41 maybe spaced in the side surface lower parts of the y-direction partition walls 23 as in the liquid device 40.

### 5. SIZE OF LIQUID DEVICE

Next, specific sizes of the liquid device 20, 40, 50 will be explained, and before that, a response time of each liquid chamber will be explained.

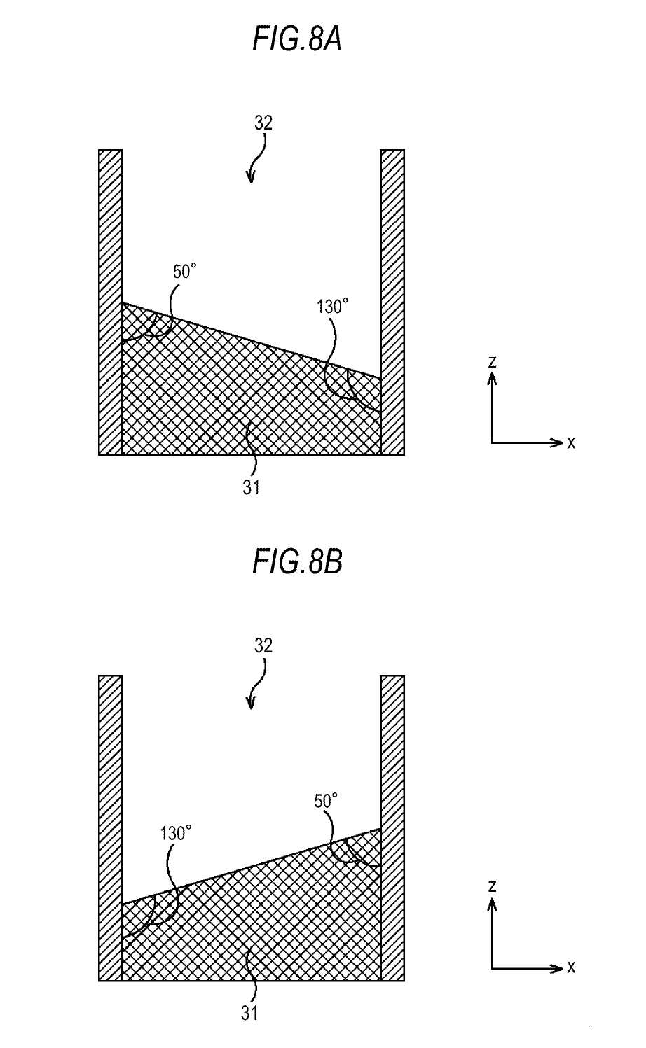

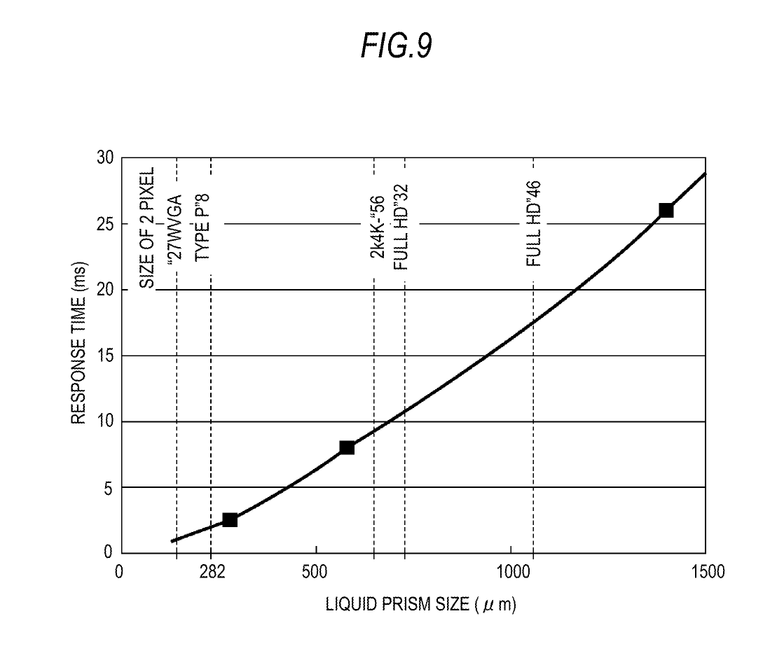

For example, when the interface of each liquid chamber is changed from a state shown in FIG. 8A to a state shown in FIG. 8B, response times necessary for the change are simulated with respect to various sizes of the liquid device, and results shown in FIG. 9 are obtained. For the simulation, the fluid simulation VOF method is used.

The horizontal axis of FIG. 9 indicates the width of one side of the xz section of the liquid chamber and the vertical axis indicates the response time. Further, the plural vertical lines correspond to various display sizes when two liquid chambers are brought into correspondence with one pixel.

For example, the response time when the width of one side of the xz section of the liquid chamber is 0.5 mm is about 6 milliseconds, and the response time when the width of one side of the xz section of the liquid chamber is 1 mm is about 15 milliseconds. That is, as shown in FIG. 9, it is known that the smaller the size of the liquid chamber, the shorter the response time, and the larger the size of the liquid chamber, the longer the response time.

To use the liquid device as lenses for three-dimensional display, a response time equal to or less than 1 ms is requested. However, in this case, it is necessary to set the width of one side of the xz section of the liquid chamber to 0.1 mm or less, and if two liquid chambers remain brought into correspondence with one pixel as shown in FIG. 9, the device may be applied only to very small displays of about three inches.

Accordingly, if the width of one side of the xz section of the liquid chamber is set to 0.1 mm and plural liquid chambers are brought into correspondence with one pixel, the device may be applied to larger displays while securing high-speed response.

To allow the respective liquid chambers to operate as prisms with interfaces at different angles, it is necessary to accurately control the voltages applied to the liquids of the respective liquid chambers, and, for the purpose, it is important to arrange wiring structures of the extraction electrodes 26a to which the partition wall side surface electrodes 24A are connected and the extraction electrodes 26b to which the partition wall side surface electrodes 24B are connected.

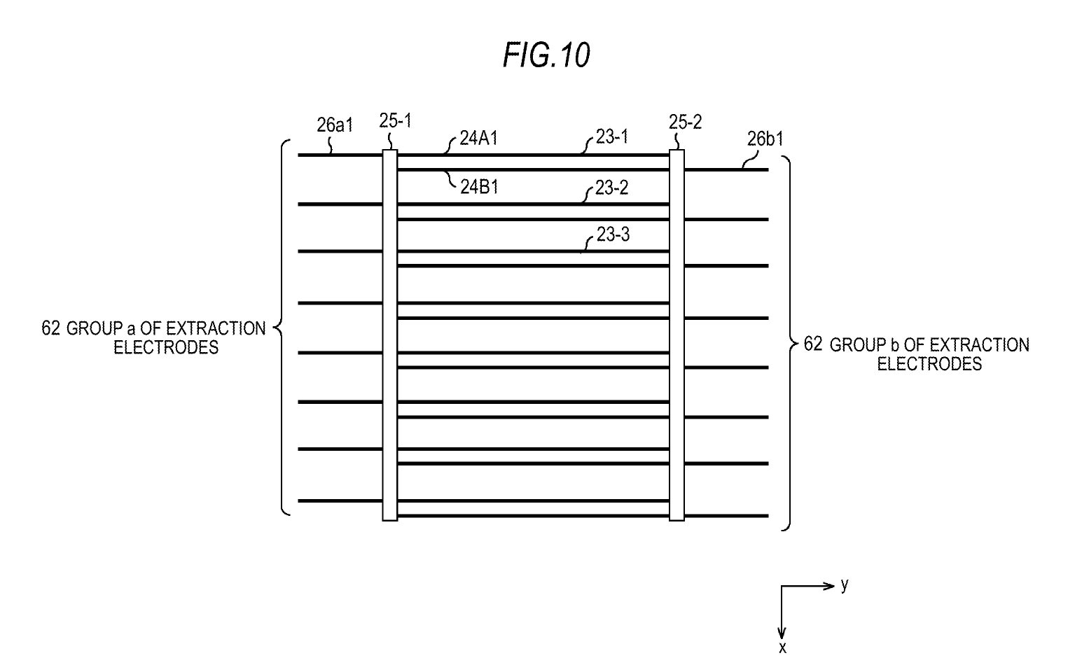

FIG. 10 shows proposed electrode structures of the extraction electrodes 26a and 26b. Note that FIG. 10 shows a section along the xy-plane of the liquid device.

As shown in FIG. 10, the extraction electrodes 26a and 26b are distributed and wired to right and left. That is, the extraction electrodes 26a are extracted from the x-direction partition wall 25-1 side and the extraction electrodes 26b are extracted from the x-direction partition wall 25-2 side. The extracted extraction electrodes 26a and 26b can be multiline-wired by thermocompression bonding of flexible electrodes or the like. By the wiring structures, the currents flown in the extraction electrodes 26a and 26b may be finely controlled and the voltages applied to the liquids of the respective liquid chambers may be accurately controlled. Therefore, the respective liquid chambers of the liquid device may be allowed to function as liquid lenses or liquid prisms.

Note that the respective liquid devices of the embodiments may be applied to display apparatuses or irradiation apparatuses for the purpose of expansion of the viewing angle and the irradiation angle and increase of the number of viewpoints in addition to the three-dimensional display.

The embodiments of the present disclosure are not limited to the above described embodiments, and various changes may be made without departing from the scope of the present disclosure.

The present disclosure contains subject matter related to that disclosed in Japanese Priority Patent Application JP 2010-169269 filed in the Japan Patent Office on Jul. 28, 2010, the entire contents of which is hereby incorporated by reference.

What is claimed is:

1. A liquid device comprising:
first and second substrates oppositely provided to each other at a distance;
first partition walls provided between the first substrate and the second substrate to extend in a first direction;
second partition walls provided between the first substrate and the second substrate to extend in a second direction different from the first direction;
first and second electrodes respectively provided on both side surfaces of the second partition walls;
liquids filling liquid chambers formed by the first and the second partition walls and having interfaces varying in response to voltages applied by the first and second electrodes; and
first and second extraction electrodes wired on the first substrate along contact lines between the first substrate and the side surfaces of the second partition walls and externally extracted from joint parts between the first partition walls and the first substrate,
wherein the first electrodes are connected to the first extraction electrodes, and
the second electrodes are connected to the second extraction electrodes.

2. The liquid device according to claim 1, wherein one of the first and second extraction electrodes is externally extracted from one end side of ends of the liquid device in the second direction, and the other is externally extracted from the other end side of the ends of the liquid device in the second direction.

3. The liquid device according to claim 2, wherein at least one or more of the first partition walls are provided between the ends of the liquid device in addition to those on the ends in the second direction.

4. The liquid device according to claim 2, wherein the first electrode is provided on an entire of one of the side surfaces of the second partition wall, and
the second electrode is provided on an entire of the other of the side surfaces of the second partition wall.

5. The liquid device according to claim 2, wherein the first electrode is provided in a region except an electrodeless region containing a part of the contact line with the first substrate of one of the side surfaces of the second partition wall, and
the second electrode is provided in a region except an electrodeless region containing a part of the contact line with the first substrate of the other of the side surfaces of the second partition wall.

6. The liquid device according to claim 2, wherein the interface between the liquids filling the liquid chamber changes to a concave curve, a convex curve, or a flat surface in response to the voltage applied by the first and second electrodes.

7. A liquid device comprising:
first and second substrates oppositely provided to each other at a distance;
first partition walls provided between the first substrate and the second substrate;
second partition walls provided between the first substrate and the second substrate;
first and second electrodes respectively provided on both side surfaces of the second partition walls;
liquids having interfaces varying in response to voltages applied by the first and second electrodes; and
first and second extraction electrodes wired on the first substrate and externally extracted from joint parts between the first partition walls and the first substrate,
wherein the first electrodes are connected to the first extraction electrodes, and
the second electrodes are connected to the second extraction electrodes.

8. A display apparatus comprising:
a display unit that performs image display;
a liquid device oppositely provided at a display surface side of the display unit; and
supply means for supplying electric power to the liquid device,
the liquid device including
first and second substrates oppositely provided to each other at a distance,
first partition walls provided between the first substrate and the second substrate to extend in a first direction,
second partition walls provided between the first substrate and the second substrate to extend in a second direction different from the first direction,
first and second electrodes respectively provided on both side surfaces of the second partition walls,
liquids filling liquid chambers formed by the first and the second partition walls and having interfaces varying in response to voltages applied by the first and second electrodes, and
first and second extraction electrodes wired on the first substrate along contact lines between the first substrate and the side surfaces of the second partition walls and externally extracted from joint parts between the first partition walls and the first substrate,
wherein the first electrodes are connected to the first extraction electrodes, and
the second electrodes are connected to the second extraction electrodes.
